(19) United States
(12) Patent Application Publication
(10) Pub. No.: US 2016/0147407 A1
(43) Pub. Date: May 26, 2016

(54) MODIFYING CONTENT WITH SINGLE MODIFIER KEY

(71) Applicant: Lenovo (Singapore) Pte. Ltd., Singapore (SG)

(72) Inventors: John Weldon Nicholson, Cary, NC (US); Scott Edwards Kelso, Cary, NC (US)

(21) Appl. No.: 14/548,607

(22) Filed: Nov. 20, 2014

(51) Int. Cl. G06F 3/0489; G06F 3/0488; G06F 3/023

(52) U.S. Cl. CPC G06F 3/0489; G06F 3/0238; G06F 3/0488

(57) ABSTRACT

One embodiment provides a method, including: receiving, from an input device, user input; detecting, at an input device, a modifier key input comprising input from a single modifier key location; determining, using a processor, a location of a cursor; and modifying, using a processor, at least one character associated with the location of a cursor based upon the modifier key input. Other aspects are described and claimed.

### BACKGROUND

Using information handling devices (e.g., smart phones, laptop computers, personal computers, tablets, personal digital assistants, etc.), people are able to enter data including characters (e.g., text, numbers, symbols, etc.) into a variety of applications (e.g., word processing, email, spreadsheet, web browser, etc.). For example, a user may use an email application to compose an email message. After entering this data, a user may want to modify (e.g., underline, capitalize, italicize, superscript, etc.) the entered data or characters.

### BRIEF SUMMARY

In summary, one aspect provides a method, comprising: receiving, from an input device, user input; detecting, at an input device, a modifier key input comprising input from a single modifier key location; determining, using a processor, a location of a cursor; and modifying, using a processor, at least one character associated with the location of a cursor based upon the modifier key input.

Another aspect provides an information handling device, comprising: a processor; at least one input device operatively coupled to the processor; a memory device that stores instructions executable by the processor to: receive, from one of the at least one input device, user input; detect, at one of the at least one input device, a modifier key input comprising input from a single modifier key location; determine a location of a cursor; and modify at least one character associated with the location of a cursor based upon the modifier key input.

A further aspect provides a product, comprising: a storage device having code stored therewith, the code being executable by the processor and comprising: code that receives, from an input device, user input; code that detects, at an input device, a modifier key input comprising input from a single modifier key location; code that determines, using a processor, a location of a cursor; and code that modifies, using a processor, at least one character associated with the location of a cursor based upon the modifier key input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of modifying content with single modifier key.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When a user enters data including characters (e.g., letters, numbers, symbols, etc.) into an application, a user may want to modify (e.g., underline, capitalize, superscript, change format, add diacritical marks, etc.) a character or plurality of characters. However, to do this a user generally has to take multiple steps usually disrupting the flow of the data entry. For example, one way to make modifications requires a user to select (e.g., highlight) the character(s) to be changed and apply the modification or reenter the character in its modified form. For example, a user may have to select the character and press a modifier key in conjunction with a non-modifier key. Using this method requires the to move the cursor by, for example, using the arrow keys, clicking the desired location with the mouse, touch the screen in the desired location, and the like. Taking these steps may disrupt the flow of the data entry, for example, if a user is typing a sentence and wants to modify a single word in the sentence, the user may have to stop typing the sentence to go back and modify the single word. This in turn may cause a disruption in the user's thoughts and may require the user to spend more time to figure out how or where to continue the data entry.

As an alternate method, a user may, rather than selecting the character, just delete the character, usually either by using the backspace key or the delete key depending on the location of the cursor. The user may then reenter the character(s) with the added modification. However, this has the same problems as before.

If a user wants to make a more substantial modification, for example, changing the format of the data, adding diacritical marks, and the like, a user generally has to take additional steps to produce this change. For example, a user may have to select the character(s) and use a series of keystrokes or select an option from a menu to effectuate the change. As an example, if a user wants to underline a character the user has to select the character and then either use a series of keystrokes (e.g., ctrl+U) or select the underline option from a menu. The menu may include a “shortcut” key on the menu bar, or may require the user to use a drop down menu and select an option from a pop-up window. For some modifications even more steps are required. For example, if a user wants to add a diacritical mark, the user usually has to search for and find the correct character in a pop-up window including hundreds of different characters. This method is even more disruptive and time consuming.

In some applications a user may be able to use a modifier key in conjunction with another key to perform some kind of modification to a user input. For example, a user may be able to press the shift key in addition to a function key to capitalize the word. Pressing the same set of keys again may produce a new modification to the same user input. However, this method requires that the user press a key in addition to the modifier key. Additionally, this method does not allow a user to configure the modification action taken by a shortcut key series. This method is also for a narrow range of modifications. In other words, all modifications that a user may want to make may not have a shortcut key series associated with them.

Some applications allow a user to create a shortcut to produce a particular modification. For example, in some word processing applications, a user can set a shortcut menu option. The desired modification button may then appear on a toolbar within the application. Additionally or alternatively, a user may be able to set a series of keystrokes as a shortcut so the user does not have to find the particular character or modification command from a menu display. For example, a user may be able to set a shortcut which recognizes a modifier key pressed in conjunction with at least one other key. This shortcut may then allow a user to press the modifier key in addition to the other set key to produce the desired character or modification. However, this requires that the user know where to find the option to set up a shortcut button or shortcut keystrokes (e.g., a modifier key used in conjunction with a non-modifier key). Additionally, even with the shortcut button or shortcut keystrokes a user has to take multiple steps, including pressing multiple keys, to effectuate the desired modification, which leads to a disruption in the flow of data entry.

Accordingly, an embodiment provides a method of character(s) modification using a single modifier key location. One embodiment receives a user input comprising at least one character. Upon detecting a modifier key input, an embodiment may determine the location of a cursor and then modify the user input based upon the cursor location and which modifier key was detected. In one embodiment, an additional modifier key input may be detected after the user input has been modified, which may cause a new modification to the user input depending on the additional modifier key input detected. In one embodiment, the modification carried out by the modifier key may be dependent on the application in which the user input was received. For example, if the user input was received in a word processing document the modification caused by selecting the alternate key may be different than if the user input was received by a software programming application. Additionally, a user may be able to, in one embodiment, configure the modifier keys to perform a particular modification. For example, a user may configure the left shift key to modify the user input preceding the cursor by italicizing the user input.

The illustrated example embodiments will be best understood by reference to the figures. The following description is intended only by way of example, and simply illustrates certain example embodiments.

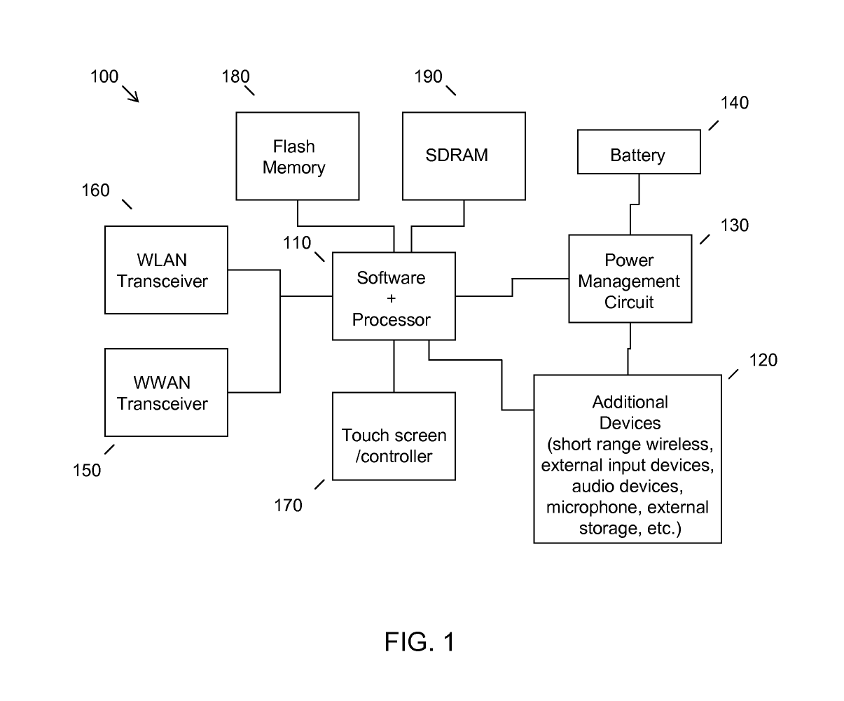

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., external input devices, for example, keyboards, mice, numeric pads, and the like. System 100 often includes a touch screen 170 for data input and display/rendering. System 100 also typically includes various memory devices, for example flash memory 180 and SDRAM 190.

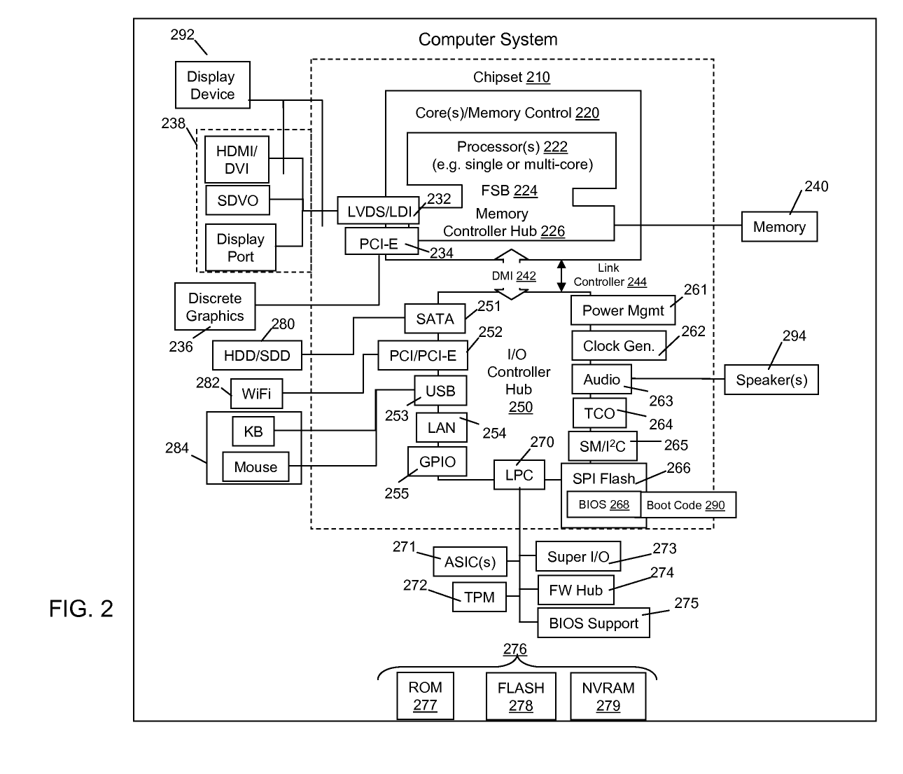

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to enter and modify data. For example, the circuitry outlined in FIG. 1 may be implemented in a tablet or smart phone embodiment, whereas the circuitry outlined in FIG. 2 may be implemented in a personal computer embodiment.

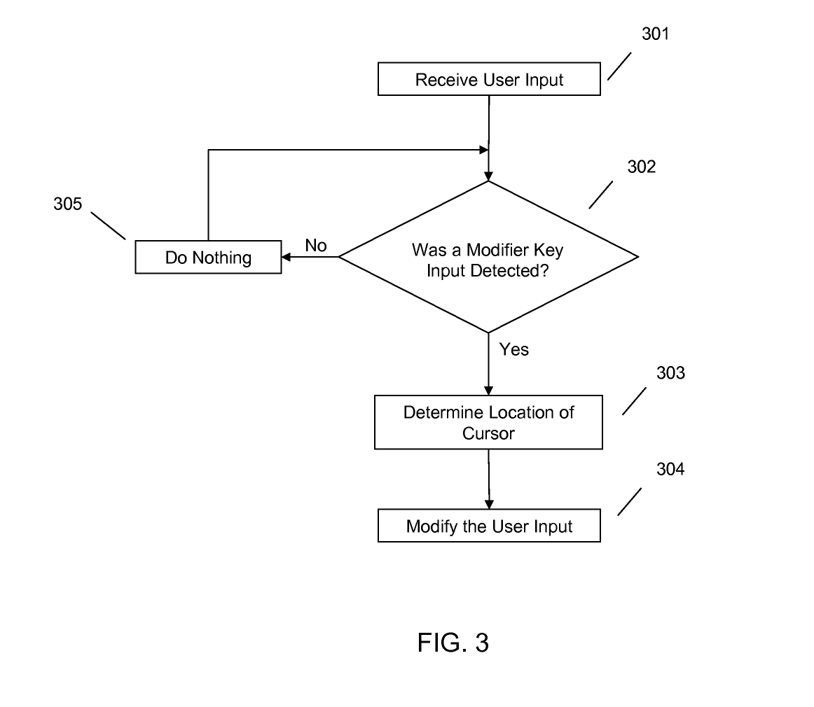

Referring now to FIG. 3, an embodiment at 301 may receive a user input. This user input may comprising at least one character (e.g., letter, number, symbol, etc.). In other words, the user input may comprise a single character or may comprise a string of characters. The input may be received from an input device (e.g., keyboard, mouse, touch screen, number pad, etc.) connected to an information handling device (e.g., smart phone, personal computer, laptop computer, tablet, eReader, etc.). For example, a user may be composing a word processing document and entering text into the document. As another example, a user may be updating a spreadsheet and entering numbers into the document. Additionally or alternatively, the user input may include input received from a secondary source. For example, the user input may comprise an email from another user. In other words, the user may not have to enter the characters to be modified, they may be received by another source. If the user input comprises more than one character, not all the characters have to be received using the same input device. For example, a user may enter a symbol using a keyboard and may then enter numbers using a numeric pad. As another example, a user may receive a document comprising characters and then enter additional characters.

At 302, an embodiment may detect if a modifier key input has been received. This modifier key input may comprise input from only a single modifier key location (“modifier key”). The single modifier key location may include, for example, an actual key on a keyboard, a depiction of a key, for example, on a touch screen, and the like. For example, the modifier key (e.g., shift key, control key, insert key, function key, windows key, etc.) may be selected by the user without the user additionally selecting another key, for example, another modifier key or a non-modifier key. For example, a user may press, on a keyboard, the shift key without pressing an additional modifier key or another non-modifier key located on an input device.

The modifier key input may additionally include receiving an input comprising multiple instances of the same modifier key. For example, the modifier key input may include the same modifier key being pressed multiple times, for example, twice in quick succession. This multiple input may cause a different result than a single input. Alternatively or additionally, the modifier key input may include receiving an input of a predetermined duration. For example, if a user holds a modifier key for a predetermined duration, which may be a default duration or configurable by the user, the modification performed may be different than if the user just presses and releases the modifier key. The modifier key input may not be received from the same input device that the user used to enter the character(s). For example, the user may enter numbers using a numeric pad, but may use the keyboard to press the control key.

If a modifier key input has not been detected at 302, an embodiment may do nothing at 305 and wait until a modifier key input is detected at 302. Alternatively, an embodiment may wait until additional user input is received at 301. If, however, an embodiment does detect a modifier key input at 302, an embodiment may, at 303, determine a location of the cursor. For example, an embodiment may determine where the cursor is located within the application in which the user input has been received. In one embodiment, the cursor location may also comprise a selection of a plurality of characters. For example, a user may select a string of characters. This string of characters would be determined, by one embodiment, to be the location of the cursor. The determination of cursor location may be used by one embodiment to determine what user input the user may wish to modify.

At 304, an embodiment may modify the user input associated with the location of the cursor determined at 303 based upon the modifier key input detected at 302. In one embodiment, the modification is carried out on the user input before the location of the cursor. For example, if a user has typed the word “penny” and the cursor is currently located after the word, an embodiment may modify the word “penny” based upon the user pressing the shift key. In an additional or alternative embodiment, the user input located after the cursor may be modified. For example, if a user has input the numbers “1234” and the cursor is located before the numbers, an embodiment may modify the numbers based upon the user pressing the control key. The modification may be made to a single character or may be made to a plurality of characters. For example, the first character of a word may be modified or the entire word may be modified. Alternatively or additionally, the modification may be performed on a plurality of characters within a single character string. For example, if the cursor is located within the middle of a character string, the modification may be made, for example, to all the characters within the character string located in front of the cursor. Whether a single character or a plurality of characters is modified may be based upon, for example, the modifier key selected, the number of times a modifier key is selected, and the like.

In the case that there is more than one user input which could be modified (e.g., the cursor is in the middle of a character string, the user input contains more than one character string, etc.), the determination of which user input to modify may be determined using a variety of methods. In one embodiment, the user input modified may always be at a particular location with respect to the cursor location (e.g., before the cursor, after the cursor, the user input in which the cursor is currently located, etc.). For example, an embodiment may be set to always modify the user input located before the cursor. The user input which gets modified may be a default setting or may be configured by the user. Alternatively or additionally, the user input which is modified may be based upon the modifier key that is pressed. For example, if the left shift key is pressed, the user input to the left of the cursor may be modified. However, if the right shift key is pressed, the user input to the right of the cursor may be modified. Modifications may also be made to user input below or above the cursor depending on the context or application. For example, if a user is entering data in a spreadsheet, modifications may be made to user input located in the cell above, below, left, or right of the cursor position.

In one embodiment, the user input which is modified may be based upon a probability. For example, an embodiment may determine which user input a user most likely would want to be modified. One embodiment may determine the probability using a calculation or score. Alternatively or additionally, the probability may be based upon a set of rules. For example, if the cursor is located in the middle of a character string (i.e., a single character or plurality of characters not separated by an empty space (e.g., space, enter, tab, etc.)), an embodiment may determine that the user would likely want that character string modified and will modify that character string. If the user input is two character strings separated by a space and the cursor is on the left side of the space, an embodiment may determine that the left character string should be modified. If, however, the cursor is on the right side of the space, an embodiment may determine that the right character string should be modified. Other methods of determining which user input to modify are contemplated and possible.

In one embodiment the modification may be the modification typically associated with the modifier key. For example, if a user presses the shift key while typing a character, the character is generally capitalized. Therefore, in one embodiment, the detection of the user pressing the shift key would cause the character to be capitalized. Using the example of “penny”, an embodiment would cause the word to become “Penny”. Alternatively, the modification may be a modification that is not typically associated with the modifier key. For example, in one embodiment, the shift key may be configured to insert or apply a particular symbol.

If a modifier key does not have an action typically associated with the key, then an embodiment may have a default modification associated with the modifier key. For example, the control key is a modifier key generally used with another key(s). In one embodiment, the control key may be set to modify the characters in a particular method, which may be based upon the type of characters included in the user input. For example, if a user has typed the numbers “1234” and the cursor is currently located in front of the numbers and the user presses the control key, an embodiment may modify the numbers by changing the format to a currency format (e.g., $12.34). However, if the user has entered text and presses the control key, the text may be modified in a different method, for example, by underlining the text.

In an additional or alternative embodiment, the modification associated with a modifier key may be configured by a user. For example, a user may set the shift key to italicize the user input rather than capitalize the user input. As another example, a user may set the control key to apply a diacritical mark. In one embodiment, the left and right modifier keys may perform different modifications. For example, the left alternate key may perform a modification different from the right alternate key.

In one embodiment, the determination of the type of modification that should be performed may be based upon the application the user input was received within. For example, if a user has opened a word processing document, a modifier key may modify a user input in one way. However, if the user presses the same modifier key while using a web browser application, the user input may be modified in a different way. In one embodiment, the modification based upon application may be a default setting. In an additional or alternative embodiment, the user may configure the modifier keys to perform differently depending on the application. This configuration may include the user indicating that the modifier key is to modify user input in one way in a specific application but modify user input in a different way in a different specific application or possibly in all other applications.

One embodiment may detect a second modifier key input after modifying the user input. In this case, the user input may be modified again depending on the second modifier key input detected. For example, if a user enters a character string and presses the shift key, an embodiment may capitalize the first letter of the character string. If the user presses the shift key again, an embodiment may capitalize the entire character string. If the user presses the shift key for a third time, a different modification may occur or the character string may be returned to its original form (i.e., no capitalization). In other words, pressing a modifier key multiple times may cause an embodiment to cycle through modifications to the user input. For example, if a user inputs an “a”, when a user presses a modifier key for the first time, the user may be presented with “à”. Upon a second modifier key press, the user may be presented with “á”. Additional modifier key presses may present the user with different modifications, for example, â, ã, ä, å, ā, \check{a}, [symbol] , [symbol] , [symbol] , \dot{a}, and the like. With a cycle of modifications, a user may be able to cycle through the modifications directionally. As an example, a user may use a left modifier key to cycle through the modifications in one direction and may use a right modifier key to cycle through the modifications in another direction. For example, if the user is the middle of the cycle, the user may be able to access the previous modification using the other modifier key.

The second modifier key input does not have to be the same modifier key. For example, a user may first press the alternate key which causes a first modification to a user input. The user may then press the shift key which may cause a second modification to the user input. This may or may not be the same modification which would be associated with pressing the shift key. For example, the alternate key may be set up to superscript a user input, while the shift key is set up to capitalize a user input. However, if a user presses the alternate key, causing the user input to become a superscript, and then presses the shift key, the user input may not necessarily be capitalized.

Accordingly, as illustrated by the example embodiments and figures, an embodiment provides a method of modifying user input including at least one character by using only a single modifier key. An embodiment may receive a user input and then detect a modifier key input. Upon detecting this modifier key input, an embodiment may determine the location of a cursor and modify the user input associated with the location of the cursor based upon the modifier key detected. In one embodiment, the modification performed may be dependant on the application in which the user input was received. Alternatively or additionally, the modification performed may be based upon a user configured setting for that particular modifier key. One embodiment may additionally receive an additional modifier key input and modify the user input again based upon the second modifier key input. Therefore, an embodiment provides a method of making modifications to a character(s) quickly and efficiently, thereby reducing the disruption to the flow of the data entry.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, from an input device, user input;
detecting, at an input device, a modifier key input comprising input from a single modifier key location;
determining, using a processor, a location of a cursor; and
modifying, using a processor, at least one character associated with the location of a cursor based upon the modifier key input.

2. The method of claim 1, further comprising identifying an application in which the user input was received and wherein the modifying is further based upon the application identified.

3. The method of claim 1, further comprising:
detecting a second modifier key input, wherein the second modifier key input comprises input from the single modifier key location; and
modifying the at least one character associated with the location of a cursor based upon the second modifier key input.

4. The method of claim 1, further comprising:
detecting a second modifier key input, wherein the second modifier key input comprises input from a different modifier key location; and
modifying the at least one character associated with the location of a cursor based upon the second modifier key input.

5. The method of claim 1, wherein the modifying comprises modifying at least one character located after the location of a cursor.

6. The method of claim 1, wherein the modifying comprises modifying at least one character located before the location of a cursor.

7. The method of claim 1, wherein the modifier key input comprises multiple instances of input from a single modifier key location.

8. The method of claim 1, wherein the modifying comprises modifying the at least one character in a manner associated with a key function associated with the single modifier key location.

9. The method of claim 1, wherein the modifying comprises modifying the at least one character in a manner configured by a user.

10. The method of claim 1, wherein the location of a cursor comprises a selection of a plurality of characters.

11. The method of claim 1, wherein the modifier key input comprises an input of predetermined duration.

12. An information handling device, comprising:
a processor;
at least one input device operatively coupled to the processor;
a memory device that stores instructions executable by the processor to:
receive, from one of the at least one input device, user input;
detect, at one of the at least one input device, a modifier key input comprising input from a single modifier key location;
determine a location of a cursor; and
modify at least one character associated with the location of a cursor based upon the modifier key input.

13. The information handling device of claim 12, wherein the instructions are further executable by the processor to identify an application in which the user input was received and wherein to modify is further based upon the application identified.

14. The information handling device of claim 12, wherein the instructions are further executable by the processor to:
detect a second modifier key input, wherein the second modifier key input comprises input from the single modifier key location; and
modify the at least one character associated with the location of a cursor based upon the second modifier key input.

15. The information handling device of claim 12, wherein the instructions are further executable by the processor to:
detect a second modifier key input, wherein the second modifier key input comprises input from a different modifier key location; and
modify the at least one character associated with the location of a cursor based upon the second modifier key input.

16. The information handling device of claim 12, wherein to modify comprises modifying at least one character located at a location selected from the group consisting of: after the location of a cursor and before the location of a cursor.

17. The information handling device of claim 12, wherein the modifier key input comprises multiple instances of input from a single modifier key location.

18. The information handling device of claim 12, wherein to modify comprises modifying the at least one character in a manner associated with a key function associated with the single modifier key location.

19. The information handling device of claim 12, wherein to modify comprises modifying the at least one character in a manner configured by a user.

20. The information handling device of claim 12, wherein the location of a cursor comprises a selection of a plurality of characters.

21. A product, comprising:
a storage device having code stored therewith, the code being executable by the processor and comprising:
code that receives, from an input device, user input;
code that detects, at an input device, a modifier key input comprising input from a single modifier key;
code that determines, using a processor, a location of a cursor; and
code that modifies, using a processor, at least one character associated with the location of a cursor based upon the modifier key input.
